(19) United States
(12) Patent Application Publication
(10) Pub. No.: US 2026/0295430 A1
(43) Pub. Date: Oct. 1, 2026

(54) Game Development Using Machine Learning to Reduce Latency

(71) Applicant: Sony Interactive Entertainment Inc., Tokyo (JP)

(72) Inventors: Xiaoyong Ye, Pleasanton, CA (US); Michael Stopa, San Mateo, CA (US); Kelvin Yong, Irvine, CA (US); Harshil Shah, Yorba Linda, CA (US)

(73) Assignee: Sony Interactive Entertainment Inc., Tokyo (JP)

(21) Appl. No.: 19/097,216

(22) Filed: Apr. 1, 2025

(51) Int. Cl. A63F 13/67; A63F 13/355; A63F 13/53; G06F 40/205

(52) U.S. Cl. CPC A63F 13/67; A63F 13/355; A63F 13/53; G06F 40/205; A63F 2300/638

(57) ABSTRACT

Techniques for described for game development. An example method can include receiving a natural language indication of a video game development task for a video game developer via a user device. The method can further include accessing a video game resource repository comprising a plurality of video game resources for a video game. The method can further include determining, via a machine learning model, a video game resource of the plurality of video game resources to be used for performing the video game development task based on the natural language indication and availability of the video game resource in the video game resource repository. The method can further include generating, via the machine learning model, a summarization of using the video game resource with respect to the video game development task. The method can further include sending the summarization of the video game resource to the user device.

### BACKGROUND

Video game debugging can be a process of identifying, analyzing, and resolving errors or glitches in video game code to ensure that the video game functions as intended. Debugging can include examining game play behavior, code performance, and player interactions to pinpoint issues and implement fixes for an enjoyable gamer experience.

### BRIEF SUMMARY

The embodiments described herein provide techniques for using a machine learning model to accept a natural language input describing a video game coding task and identify resources to be used to perform the task.

A computing system can be configured to accept natural language input that is inputted by a video game developer and describes a task to improve some aspect of a video game. The computing system can include a machine learning model such as a large language model (LLM), a decoder model (e.g., generative pre-trained transformer (GPT) model), an encoder model (e.g., bi-directional representations from transformers (BERT) model), an encoder-decoder model (e.g., text-text transfer transformer (T5)) or other model. The machine learning model can be trained to use language processing techniques to discern the context of the natural language input. The machine learning model can further be trained to translate the context of the natural language input to identify resources that the video game developer can use to perform the task. In addition, the machine learning model can be trained to provide guidance in the form of helpful hints for understanding the context of resources and using the resources. The machine learning model can provide the identity of the resources and the guidance in a natural language response to the video game developer.

The computing system can further assess the resources and the network conditions to determine an optimal sequence for the video game developer to receive the resources. For example, the computing system can assess network conditions and the sizes of the resources to determine optimal sequences that correlate available bandwidth with the size of the resources.

### BRIEF DESCRIPTION OF THE DRAWINGS

FIG. 1 is an illustration of an example computer system that presents a dashboard, according to one or more embodiments.

FIG. 2 is an illustration of an example system for game development using machine learning, according to one or more embodiments.

FIG. 3 is an illustration of an example signaling diagram for game development using machine learning, according to one or more embodiments.

FIG. 4 is an illustration of an example signaling diagram for game development using machine learning, according to one or more embodiments.

FIG. 5 is an illustration of an example training system for a machine learning model, according to one or more embodiments.

FIG. 6 is an illustration of an example natural language input and an example natural language output, according to one or more embodiments.

FIG. 7 is an example process for game development using machine learning, according to one or more embodiments.

FIG. 8 is an example process for training a machine learning model, according to one or more embodiments.

FIG. 9 illustrates an example of a hardware system suitable for implementing a computer system, according to embodiments of the present disclosure.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

Video game developers can face challenges when downloading files they need to work on, primarily due to the sheer size and complexity of game assets and development files. Modern video games can involve high-resolution textures, three-dimensional (3D) models, audio files, and extensive codebases, which can result in individual files or repositories reaching hundreds of gigabytes or even terabytes. Downloading these files requires robust internet infrastructure, and any interruptions or bandwidth limitations can delay workflows significantly. Version control systems, such as Git, while useful for collaborative development, can also struggle with large binary files or complex branching structures, further complicating the process. Additionally, developers must ensure that the files are downloaded securely to prevent unauthorized access or corruption, particularly in an industry where intellectual property theft or leaks can have severe consequences. These technical and logistical hurdles can slow down the iterative nature of game development, placing additional strain on project timelines and team productivity.

A computing system can receive a natural language indication of a video game resource task provided by a video game developer via a user device. This natural language input can include descriptions of tasks such as creating a specific in-game asset, modifying game mechanics, or debugging certain features. Unlike traditional systems that require developers to manually search or navigate extensive repositories, this natural language interface streamlines the task initiation process by allowing developers to describe their requirements in conversational terms. By leveraging natural language processing (NLP), the computing system can interpret the developer’s intent and translate it into actionable queries, reducing the cognitive load on the developer and minimizing the time spent searching for resources manually. This approach addresses the challenge of navigating large and complex resource repositories by providing an intuitive and efficient entry point for developers to access the assets they need.

After interpreting the natural language task, the computing system can access a video game resource repository comprising a plurality of video game resources. These resources may include 3D models, high-resolution textures, sound files, scripts, animations, or other game assets stored in structured or unstructured formats. The repository may also include metadata, version history, and access permissions for each resource. By integrating with the repository, the computing system can eliminate the need for developers to manually browse or download large volumes of data to locate relevant assets. Furthermore, the computing system can ensure utilization of bandwidth and storage by identifying and retrieving only the assets that are pertinent to the developer's task. For example, selecting low resolution textures when a developer is working on the physics engine. This selective access can mitigate the difficulties associated with downloading massive game files, allowing developers to work more efficiently without being overwhelmed by unnecessary data.

Using a machine learning model, the computing system can determine the specific video game resource(s) from the repository that are most relevant to the developer's task. The machine learning model can evaluate the natural language input against metadata, content attributes, and version availability of resources in the repository. For example, if the developer requests a "high-detail forest texture," the model can identify the most suitable texture files that meet the requested parameters while considering factors like file availability, compatibility with the game engine, and prior usage. By automating this determination process, the computing system can reduce reliance on manual searches and ensure developers receive the most appropriate resources without delays. Additionally, the machine learning model can continuously improve its predictive accuracy by learning from prior developer interactions, thereby enhancing its ability to address complex and nuanced requests over time.

Once the relevant video game resource is identified, the computing system can generate a natural language summarization of how the resource can be utilized in the context of the developer’s task. This summarization, created using NLP techniques, can provide actionable insights into the resource's properties, potential use cases, and integration steps, effectively bridging the gap between technical resource details and the developer's intended application. For instance, the summary might describe how a selected texture file can be applied to a specific scene, including its resolution, layering requirements, and compatibility with the rendering pipeline. This information is then sent to the developer’s user device, enabling them to quickly understand and implement the resource without needing to analyze the raw data manually. By presenting these insights in natural language, the computing system can not only accelerate the development workflow but also minimize errors, ensuring that developers can focus on creative and technical tasks without being hindered by logistical challenges.

The above-described techniques can offer technical advantages over conventional systems by automating and streamlining the retrieval and utilization of video game resources through natural language processing and machine learning. Traditional systems can require developers to manually search extensive repositories, navigate complex file structures, and download large, often unnecessary files, leading to inefficiencies in time, bandwidth, and storage. In contrast, the techniques described herein can leverage machine learning to intelligently identify and retrieve only the most relevant resources based on the developer's natural language input, significantly reducing the amount of data transferred and processed. Additionally, the generation of natural language summarizations eliminates the need for developers input commands via a keyboard, to interpret raw data or metadata, providing clear, actionable insights that accelerate task implementation. By improving resource discoverability, optimizing data management, and enhancing usability, the herein described computing system can reduce the cognitive and logistical burdens on developers, enabling faster workflows and more effective use of computational and network resources in the context of modern video game development.

In the interest of clarity of explanation, the embodiments may be described in connection with a video game system including a video game console. However, the embodiments are not limited as such and similarly apply to any other type of a computer system. Generally, a computer system presents a dashboard in a GUI on a display. The dashboard presents UI elements, each corresponding to an application, service, or collection of information.

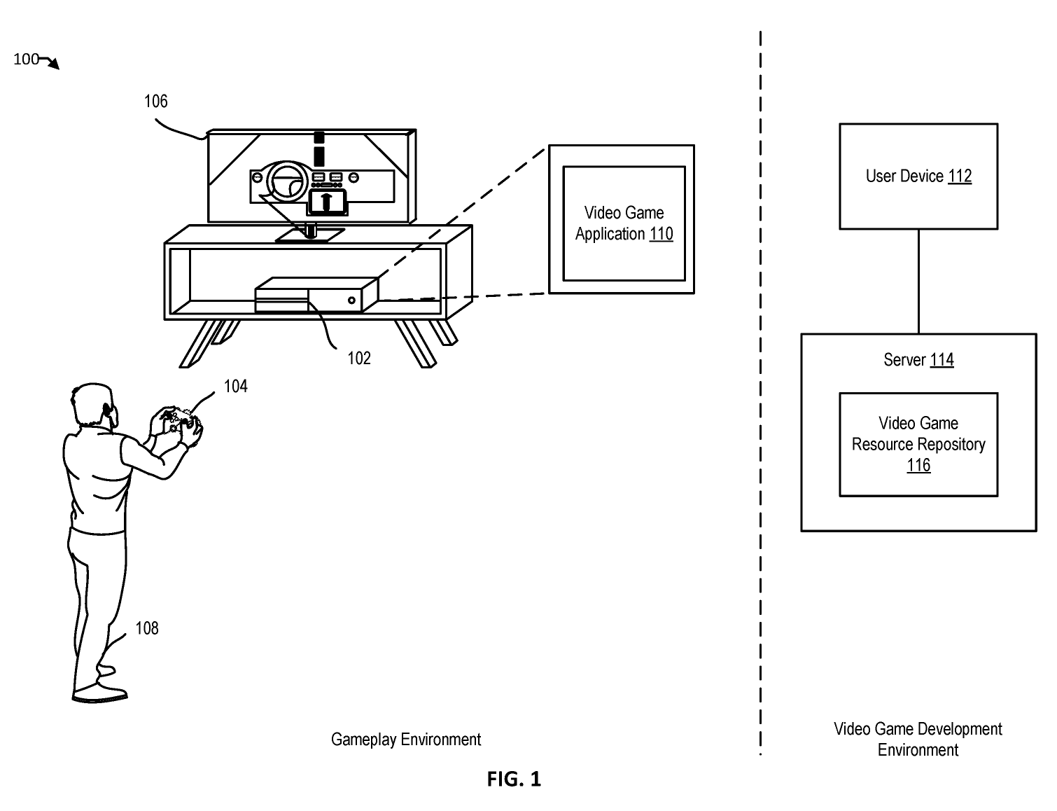

FIG. 1 is an illustration 100 of an example computer system that presents a dashboard, according to an embodiment of the present disclosure. FIG. 1 presents a gameplay environment for playing a video game application. FIG. 1 also presents a video game development environment. The gameplay environment is described and then the video game development environment is described. As illustrated, the computer system includes a video game console 102, a video game controller 104, and a display 106. Although not shown, the computer system may also include a backend system, such as a set of cloud servers, that is communicatively coupled with the video game console 102. The video game console 102 is communicatively coupled with the video game controller 104 (e.g., over a wireless network) and with the display 106 (e.g., over a communications bus). A video game player 108 operates the video game controller 104 to interact with the video game console 102. These interactions may include playing a video game presented on the display 106, interacting with a menu presented on the display 106, and interacting with other applications of the video game console 102 (e.g., with media applications to stream media from an online content source or to play a media file from the local storage of the video game console 102).

The video game console 102 includes a processor and a memory (e.g., a non-transitory computer-readable storage medium) storing computer-readable instructions that can be executed by the processor and that, upon execution by the processor, cause the video game console 102 to perform operations related to various applications. In particular, the computer-readable instructions can correspond to program codes for the various applications of the video game console 102 including video game application 110, video game application 112, controller application 114, and audio application 116. A video game application, such as video game application 112, generally represents a computer application executable to present video game content, receive user interaction with the video game content, and accordingly update the video game content. The availability of a video game application, and/or other type of computer application to the video game player 108 via the video game console 102 can depend on a user identifier of the video game player 108 (e.g., upon a login to the video game console 102, the availability of the computer applications can depend on the user identifier used in the login).

The video game application 110 can present image information, such as the visual frames of the video application. In response to an interaction with a video game controller 104, the video game application 110 can display a movement in the video game application that corresponds to the interaction. For example, if the video game controller 104 is interacted with to indicate forward motion, the video game application can cause an image of a character to appear to move forward. The video game application can further present audio corresponding to the video game application. The audio information can include, for example, music presented during game play,

The video game controller 104 is an example of an input device. The video game controller 104 may allow the video game player 108 to interact with one or more GUIs presented by the video game console 102 on the display 106. For example, using one or more directional control inputs (e.g., a joystick and/or a directional pad) the user can navigate to and within various menus, dashboards, and UI elements. The interaction with the video game controller 104 can be converted into electrical signals and transmitted to a cloud server as controller information. Other types of the input device are possible including, a keyboard, a touchscreen, a touchpad, a mouse, an optical system, a microphone, a camera, or other user devices suitable for receiving input of a user. For example, a microphone may allow the video game player 108 to interact with the GUIs using various voice commands. As another example, a camera may allow the video game player 108 to interact with the GUIs using various gesture commands.

Upon an execution of the video game application 110 by the video game console 102, a rendering process of the video game console 102 presents video game content (e.g., illustrated as a car race video game content) on the display 106. Upon user input from the video game controller 104 (e.g., a user push of a particular key or button), the rendering process also presents the menu. Additionally, or alternatively, the menu may be presented as an initial landing page in response to a user powering-on the video game console 102 and/or waking the video game console 102 from a suspended state. Depending on the user input, the menu corresponds to the home UI page, a landing page, or the like. The menu can be presented in a layer over the video game content.

The video game development environment can include an environment for developing the video game application 110. For example, one or more video game developers can use a user device 112 to access a server 114 that stores a video game resource repository 116. The video game resource repository 116 can include various resources, for example, source code, tools, libraries, or other resources. One or more developers can use the resources in the video game resource repository 116 to generate the video game application 110.

As an example, a developer can be tasked with optimizing the behavior of non-player characters (NPCs). The developer can access the video game resource repository 116 that includes a vast number of resources that the developer can navigate to select one or more resources. The video game repository 116 is not necessarily organized for the video game development task. Therefore, the developer may have to navigate a large volume of resources before deciding which resources to access. The developer can access, for example, a game engine and a codebase and begin debugging the code to optimize the behavior of the NPCs. The developer may then run a simulation to determine whether the debugging optimized the NPC behavior.

As indicated above, selecting and accessing the resources can be an arduous task. The embodiments herein provide techniques for using a natural language input to a machine learning mode to assist in identifying the resources to use for a video game development task. In further embodiments, the machine learning model can be in communication with an autonomous agent that can perform various video game development tasks based on the natural language input.

Although FIG. 1 illustrates that the different applications are executed on the video game console 102, the embodiments of the present disclosure are not limited as such. Instead, the applications can be executed on the backend system (e.g., the cloud servers) and/or their execution can be distributed between the video game console 102 and the backend system.

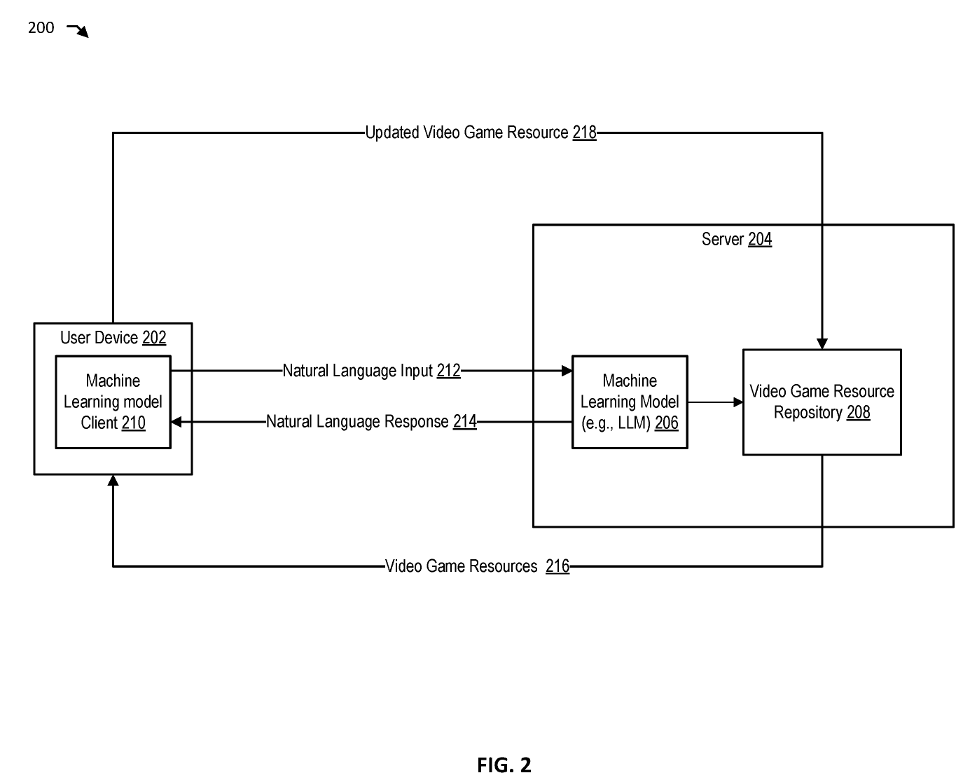

FIG. 2 is an illustration 200 of an example system for game development using machine learning, according to one or more embodiments. As illustrated, a user device 202 (e.g., user device 112), which can include a machine learning model client is in communication with a server 204 (e.g., server 114), which can run a machine learning model 206 (e.g., a large language model (LLM)) and a video game resource repository 208 (e.g., video game repositor 116). The user device 202 can be a game developer’s computing device used to download code, upload code, edit code stored on a server, or other purpose. The code can be used for a video game application 110, such as a game played on the console 102. The machine learning model can be trained to process a natural language input (e.g., “I am going to be working on the physics engine for character x, please identify the resources I need to use.”) and convert the natural language into queries that can be used to search the video game resource repository 208 for resources. The user device 202 and the server 204 can communicate with each other to exchange of task instructions, resource retrievals, and updates to the video game code.

The user device 202 can include, via the machine learning model client, a user interface for the video game developer to provide a natural language indication of a video game coding task. This natural language input can include, for example, a description of a coding task, such as implementing new gameplay mechanics, fixing bugs, or integrating new assets into the game. The machine learning client 210 can transmit the video game developer's natural language input to the machine learning model 206 running on the server 204 for further processing. This approach can obviate the video developer manually navigating a complex file system of the video game resource repository or understand intricate technical details of the resources to properly identify the resources to be used for the task.

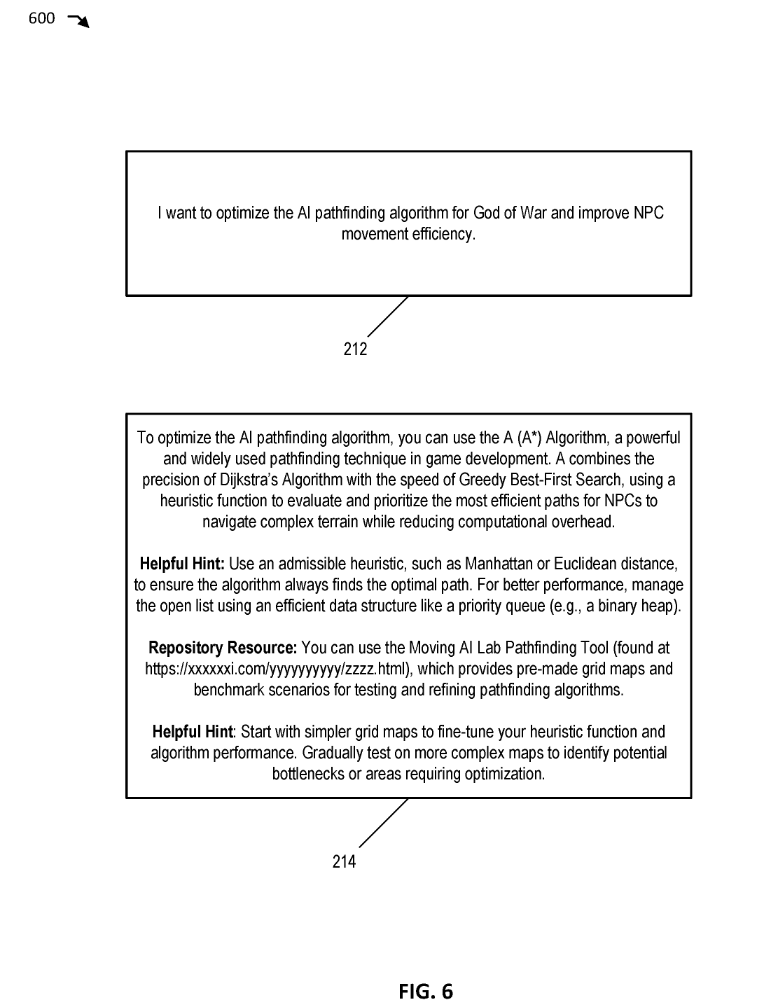

The machine learning model (e.g., an LLM) 206 can process the natural language input 212 to identify the resources for the specific task requirements. An LLM can be a deep learning model that is trained on a vast dataset for understanding and generating human-like text. For example, the machine learning model 206 can process the natural language input 212 and tokenize the input into smaller units (e.g., tokens). The machine learning model 206 can encode the tokens by processing the tokens through a series of neural network layers. This process can capture the relationships between the tokens based on the entirety of the natural language input. Then, based on the training, the machine learning model 206 can generate probabilities as to each resource that may be used to perform the video game coding task. The machine learning model 206 can then determine one or more resources, wherein the probability of each resource is based on the selection of a previous resource. Based on the probabilities, the machine learning model 206 can determine each resource that a video game developer may access to complete the video game coding task. The time required for the machine learning model 206 to identify the resources can be less than the time that a video game developer may need to manually determine the resources. For a less experienced video game developer the disparity in time may even be greater than for a highly experienced video game developer. An example of a natural language input 212 is provided with respect to FIG. 6.

In some embodiments, the video game resource repository 208 can be located within the server 204, In other embodiments, the video game resource repository 208 can be external to the server 204. The video game resource repository 208 can store video game resources, including 3D models, textures, audio files, scripts, and other game resources.

After identifying the relevant resources, the machine learning model 206 can generate a natural language response 214 that includes assistance to guide the developer in utilizing the retrieved resources or performing the specified task. The machine learning model 206 can generate this assistance 206 and deliver it to the user device 202 to be displayed via the user interface. The natural language response 214 can include, for example, guidance instructions on how to integrate a specific asset into the game engine, how to modify a particular segment of code, or other guidance in natural language. By presenting this information in an accessible format, the machine learning model 206 can reduce the cognitive burden on the video game developer and accelerate the coding process. An example of a natural language response 214 is provided with respect to FIG. 6.

The video game developer can access the resources via the user device 202 through various techniques. For example, in some embodiments, the machine learning model 206 can interface with the video game resource repository 208 and provide control instructions to transmit the resources 216 to the user device. Upon receiving the instructions from the machine learning model 206, the video game resource repository can retrieve the resources for the specified task and transmit the video game resources 216 to the user device 202.

In some embodiments, the machine learning model 206 can account for various data and networking parameters when determining what to transmit to the user device 202 and in what sequence. For example, the server 204 can provide the machine learning model 206 with information on network bandwidth for transmitting a resource to the user device 202. If there is high bandwidth, the machine learning model may instruct the video game resource repository 208 to transmit a large file. If, however, the bandwidth is low, the machine learning model may instruct the video game resource repository 208 to transmit a smaller file. For example, if the machine learning model 206 has identified two files and one file is larger than the other file, the machine learning model may instruct the video game resource repository 208 to transmit the smaller file rather than the larger file. In some further embodiments, the machine learning model 206 may instruct the video game resource repository 208 to wait after sending a file for a time interval before sending a second file. Returning to the example from above, this time interval may provide the network to gain more bandwidth to transmit a larger file. The machine learning model 206 may also instruct the video game resource repository 208 to wait for a time interval to provide the video game developer time to work on first file before sending a second file. The machine learning model 206 can be trained on historical data as to the amount of time that a video game developer uses a resource to perform a type of task. For example, task one can require resource A and resource B. To complete task one, a video game developer may use resource A for time interval x (e.g., one hour or some other time interval) and then move on to using resource B. If the video game developer A checks out resource B, then another video game developer may not be able to access resource B. Therefore, the machine learning model 206 can instruct the video game resource repository 208 to transmit resource A, wait for a time interval of one hour, and then transmit resource B.

In another embodiment, rather than instructing the video game resource repository 208 to transmit resources to the user device 202, the natural language response 214 can identify the resources that are to be used to complete the task. In this embodiment, the video game developer can elect to download the resources based on the developer’s desired order. Furthermore, the natural language response 214 can provide guidance in natural language for the developer to understand the identified resources, any interdependencies between the resources, and how to edit the resources.

This embodiment can also be available for resources that may be accessed directly on the video game resource repository 208. For example, there may be certain resources that due to various reasons (e.g., size, complexity, security, or other reasons) that may not be downloadable to the user device 202. Therefore, the natural language response can identify these reasons, and in some embodiments indicate that the resources may not be downloaded to the user device 202. In yet another embodiment, a combination of the above techniques can be performed. For example, the machine learning model 206 can provide a natural language response 214 that identifies each of the resources to be used to complete the task. The machine learning model can instruct the video game resource repository 208 to transmit certain identified resources to the user device 202. The video game developer can elect to manually download the other identified resources or access the resources if they are not available for downloading.

The video game developer can use the user device 202 to update the resource and, if downloaded, transmit the updated video game resource 218 back to the video game resource repository 208. The video game resource repository 208 can replace an older copy of the resource with the updated video game resource 218. In instances that the video game developer accessed the video game resource at the video game resource repository 208, the resource is automatically updated as the video game developer performs the task.

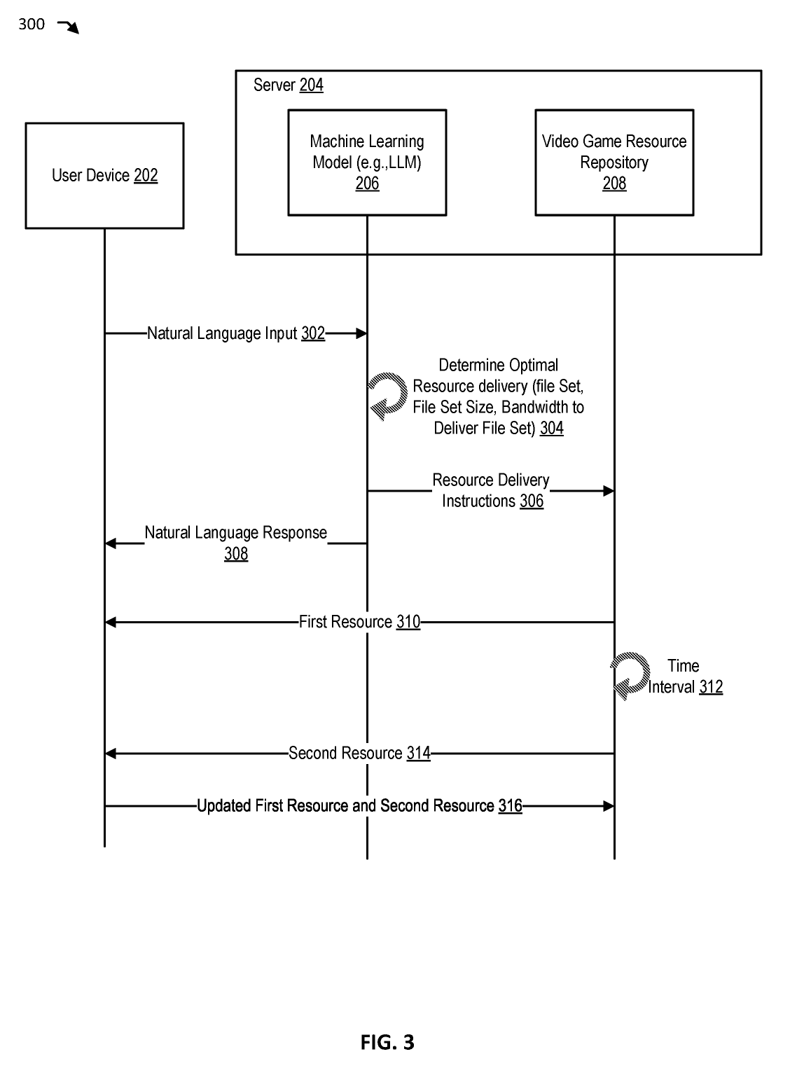

FIG. 3 is an illustration 300 of an example signaling diagram for game development using machine learning, according to one or more embodiments. As illustrated, a user device 202 is in communication with a server 204. The server 204 can include a machine learning model 206 and a video game resource repository 208. As indicated above, in some embodiments, the video game resource repository 208 can be external to the server 204.

At 302, the user device 202 can transmit a natural language input (e.g., natural language input 212) to the server 204. In particular, a user interface of a machine learning model client can be used to input a natural language indication of a task to be performed on a video game resource. The natural language input can be received by a machine learning model 206 running on the server 204. The machine learning model 206 can use language processing techniques to determine a semantic meaning of the natural language input. The machine learning model 206 can further be trained to identify available resources in the video game resource repository 208 that can be used to perform the task. At 304, the machine learning model 206 can determine the resources and optimal delivery of the resources. For example, the machine learning model 206 can receive information, such as a file set, a file set size bandwidth, from the server and/ or the video game resource repository 208. The machine learning model 206 can use this information to determine an optimal delivery sequence for the resources.

At 306, the machine learning model can transmit the delivery instructions to the video game resource repository 208. The machine learning model 206 can further transmit a natural language response (e.g., natural language response 214) to the user device 202. As indicated above, this can apply to resources that can be delivered to the user device 202. In some instances, either the resources cannot be delivered to the user device 202, or the machine learning model is not configured to interface with the video game resource repository 208. In those instances, the machine learning model 206 can transmit the natural language response to the user device 202. In either case, the natural language response can identify one or more resources and provide guidance (e.g., helpful hints) for using the resource and completing the task.

At 310, the video game resource repository 208 can transmit the first resource to the user device. As indicated above, in some embodiments, the machine learning model 206 can instruct the video game resource repository 208 to wait for a time interval after transmitting the first resource. In these embodiments, at 312, the video game resource repository 208 can wait for a time interval indicated by the machine learning model 206. At 314, at the expiration of the time interval, the video game resource repository 208 can transmit the second resource to the user device 202. A video game developer can update the first resource and the second resource and transmit the updated resources back to the video game resource repository 208 at 316. It should be appreciated, that once the user device 202 had downloaded to the resources, the video game developer can use as much time as the video game developer needs to complete the task. Therefore, in some instances, the user device may have transmitted the updated first resource back before receiving the second resource. Or in other instances, the user device 202 can have transmitted the updated second resource back to the video game resource repository 208 before transmitting back the updated first resource.

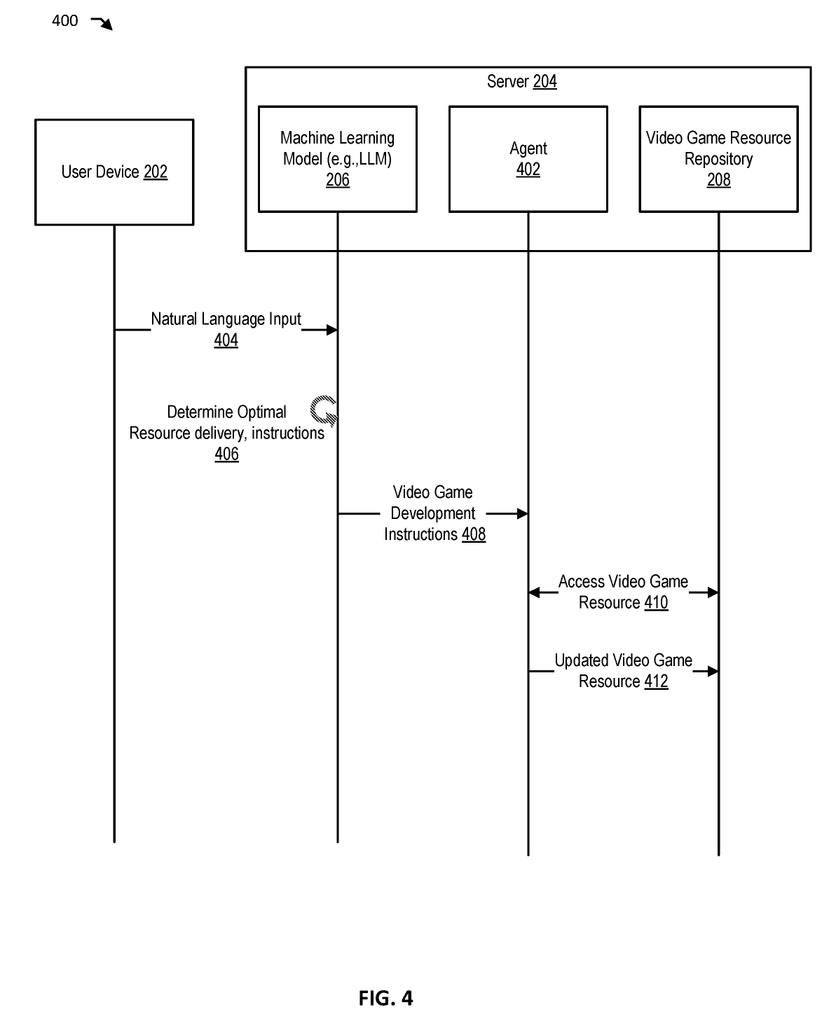

FIG. 4 is an illustration 400 of an example signaling diagram for game development using machine learning, according to one or more embodiments. In some embodiments, a machine learning model (e.g., a machine learning model 206) can communicate with an agent to perform one or more video game development tasks. As illustrated, a user device 202 can be in communication with a server 204. The server 204 can include a machine learning model 206, an agent 402, and a video game resource repository 208. The agent 402 can be an artificial intelligence based software that is operable to autonomously perform video game development tasks.

At 404, the user device 202 can transmit a natural language input (e.g., natural language input 212) to the server 204. At 406, the machine learning model 206 can determine the resources and determine instructions for an agent 402 to perform a video game development task (e.g., change a video game dungeon layout) indicated by the natural language input.

At 408, the machine learning model 206 can transmit instructions to the AI agent 402. At 410, and in response to the receiving the instructions, the agent 402 can access a video game resource from the video game repository 208. In some embodiments, the agent 402 can access the video game resource (e.g., game engine) at the video game repository 208. In other embodiments, the agent 402 can download the video game resource into a dedicated file and operate on the video game resource in the file. The agent 402 can perform the video game development task, and at 412 return the updated video game resource to the video game resource repository 208.

As an example, a natural language input can include an indication of a video game development task, such as redesigning a level (e.g., “I want to redesign level three for God of War.’). The natural language input can further include additional information, such as “I want to make it harder,” or “I want to add a dungeon.” Based on the natural language input, the machine learning model 206 can generate and transmit instructions for the agent 402 to redesign level three for God of War. The agent 402 can access the video game repository 208 for one or more resources to be used for the video game development task. For example, the agent 402 can access a game engine (e.g., Unreal engine or other engine), virtual assets, such a pre-defined models, textures, or animations, pred-defined sound effects or other resources. The agent 402 can then perform the video game development task (e.g., updated level three) using the one or more video game development resources. Once the agent 402 has complete the task, the agent 402 can provide the updated resource to the video game repository 208.

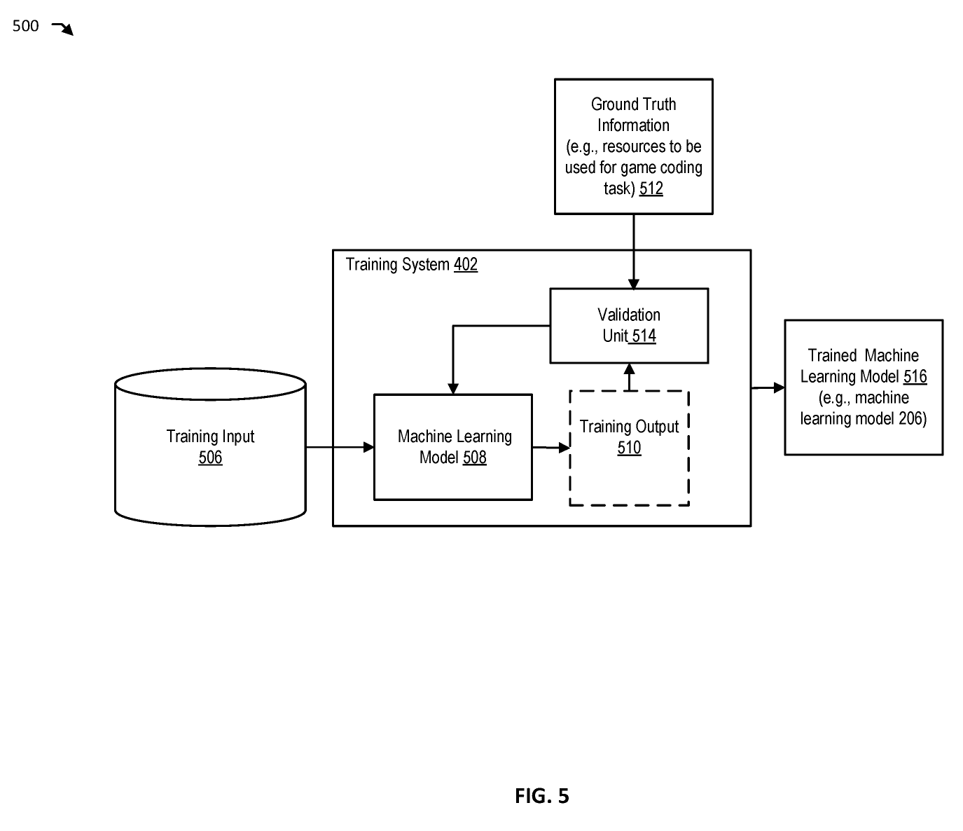

FIG. 5 is an illustration 500 of an example training system for a machine learning model, according to one or more embodiments. As illustrated, a training system 502 can be configured to train a machine learning model 504 to be capable of processing natural language descriptions of video game coding tasks and outputting relevant resources and helpful hints for implementing such tasks. The training system 502 can receive a training input 506 (e.g., game development tasks, resources, network configuration, developer skill, or other input. This input can represent a natural language description of a coding task, such as optimizing AI pathfinding (e.g., how an AI NPC moves from one point to another point) or implementing dynamic features. The machine learning model 504 is to be trained to associate natural language inputs with video game development tasks. The training input 506 can be processed by the machine learning model 508. The machine learning model can generate a training output 510, which can include a resource to be used to perform the task and guidance for using the resource.

To guide the training process, the training system 502 can use ground truth information 512, which can act as a reference dataset containing predefined mappings between coding tasks and their corresponding resources and hints. The training system 502 can provide the ground truth information 512 to the validation unit 514, which can evaluate the training output 510 generated by the machine learning model 508. For example, the validation unit 514 can compare the model's training output 510 against the ground truth information 512 and assess its accuracy and relevance. For example, the validation unit 514 can use a loss function Through this comparison, the training system 502 system can identify discrepancies and provides feedback to refine the model.

To improve the accuracy , the training system 502 can update the weights of the machine learning model. for example, the training system 502 can update the weights to minimize the loss function. This training output 510 can be iteratively refined as the machine learning model 508 undergoes additional training cycles. The feedback loop ensures that the machine learning model 508 can learn to produce accurate and contextually appropriate results over time.

Once the training process achieves a satisfactory level of accuracy and consistency, the training system 502 can output the trained machine learning model 516. This trained machine learning model 516 (e.g., machine learning model 206) can be capable of analyzing natural language descriptions of video game coding tasks and providing developers with actionable resources and helpful hints tailored to the specified task. The overall system is designed to streamline the process of identifying relevant tools and guidance for video game development, enhancing developer efficiency and productivity.

FIG. 6 is an illustration 600 of an example natural language input and an example natural language output, according to one or more embodiments. As illustrated, an example natural language input 212 is provided. The natural language input 212 can be generated by a video game developer using a user interface at the user device. As illustrated, the video game developer has inputted that they want to optimize an AI pathfinding algorithm for a video game application (e.g., God of War). In response to the natural language input 212, a machine learning model 206 can access a video game resource repository 208, determine which resources are available, and provide a natural language response 214.

As illustrated, the natural language response 214 indicates that the video game developer is to use an A* algorithm and a Moving AI Lab pathfinding tool. The natural language response 214 further provides helpful hints for using each of these resources. These helpful hints can provide necessary guidance to both an experienced video game developer and an inexperienced video game developer.

It should be appreciated that the natural language input 212 does not indicate that the machine learning model 206 is to identify any resources or provide any helpful hints. Rather the machine learning model 206 can be trained to receive a natural language input 212 that may not be clear as to the task that the machine learning model 206 is to perform, and to generate a natural language response that identifies an appropriate resource and provides guidance through helpful hints.

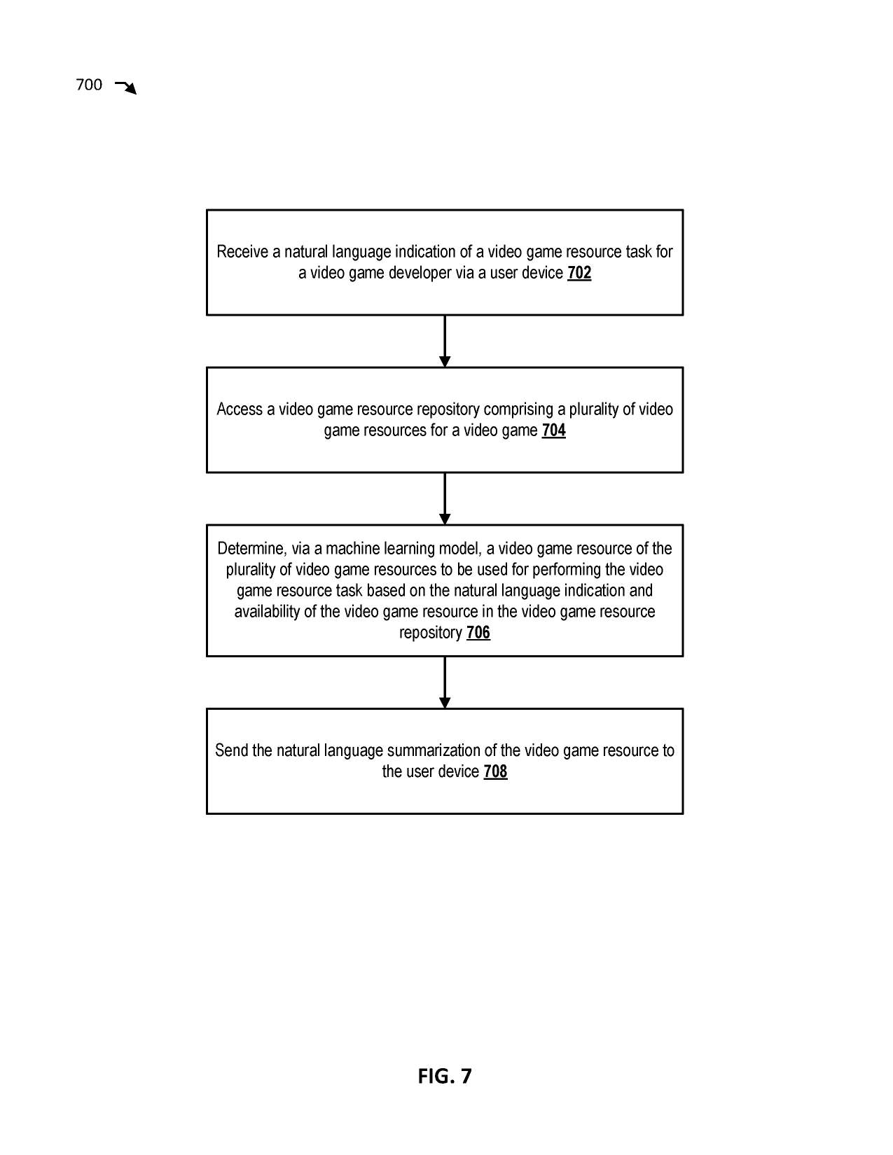

FIG. 7 is an example process 700 for game development using machine learning, according to one or more embodiments. At 702, the process 700 can include a computing system (e.g., server 204) receiving a natural language indication (e.g., natural language input 212) of a video game development task for a video game developer via a user device (e.g., user device 202).

In some embodiments, the computing system, via the machine learning model, can transmit a message to the user device indicating a clarifying question as to the video game development task. For example, if the natural language indication is unclear, the machine learning model can engage in a natural language conversation to clarify the task. The machine learning model can process a response from the user device indicating a clarification of the video game development task. The video game resource can further be determined based on the response.

At 704, the process 700 can include the computing system accessing a video game resource repository comprising a plurality of video game resources for a video game.

At 706, the process 700 can include the computing system determining, via a machine learning model (e.g., machine learning model 206), a video game resource of the plurality of video game resources to be used for performing the video game development task based on the natural language indication and availability of the video game resource in the video game resource repository.

In some embodiments, the machine learning model can parse the natural language indication of the video game development task. The machine learning model can determine a video game concept associated with the video game development task based on the parsing. The video game resource can further be based on the video game concept.

In some embodiments, the computing system can determine a second video game resource for performing the video game development task. The computing system can then determine a time interval for performing a video game resource subtask (e.g., using the first resource as described in FIG. 3). The computing system can then generate control instructions for the video game resource repository to transmit the second video game resource to the user device based on expiration of the time interval.

In some embodiments, the computing system can determine a video game developer context (e.g., skill level of video game developer, employee role of video game developer, or other context) with respect to the video game developer performing the video game development task, wherein the video game resource is further determined based on the video game developer context. The context can be determined, for example, by accessing a database of employee records, prompting a developer to indicate a skill level, or an unprompted self-reporting of the developer as to skill level.

In some embodiments, the computing system can determine that a second video game developer is using a second video game resource to perform the video game development task. For example, both developers can be contemporaneously working on a game development task for a video game application. Furthermore, if one video game developer updates one video game resource, this may affect how the other video game developer can update the other video game resource. The computing system can then determine an association between the video game resource and the second video game resource. In these embodiments, the video game resource is determined based on the association.

In some embodiments, the computing system can determine a size of the video game resource. The computing system can then determine a second size of a second video game resource stored in the video game resource repository. The second video game resource can be associated with the video game development task. The computing system can then compare the size of the video game resource and the second size of the second video game resource, where determining the video game resource is based on the comparison. In some embodiments, the computing system can determine a size of the video game resource. The computing system can determine a bandwidth for transmitting the video game resource to the user device via a network, wherein determining the video game resource is based on the bandwidth. In some embodiments, the computing system can determine a type of the video game resource. The computing system can then determine a second type of a second video game resource. The computing system can then determine a sequence for transmitting the video game resource and the second video game resource based on the type and the second type.

At 708, the process 700 can include the computing system generating, via the machine learning model, a natural language summarization (e.g., natural language response 214) of using the video game resource with respect to the video game development task.

At 710, the process 700 can include the computing system sending the natural language summarization of the video game resource to the user device.

In some embodiments, the computing system can generate control instructions for the video game resource repository to transmit the video game resource to the user device. The computing system can then transmit the control instructions to the video game resource repository.

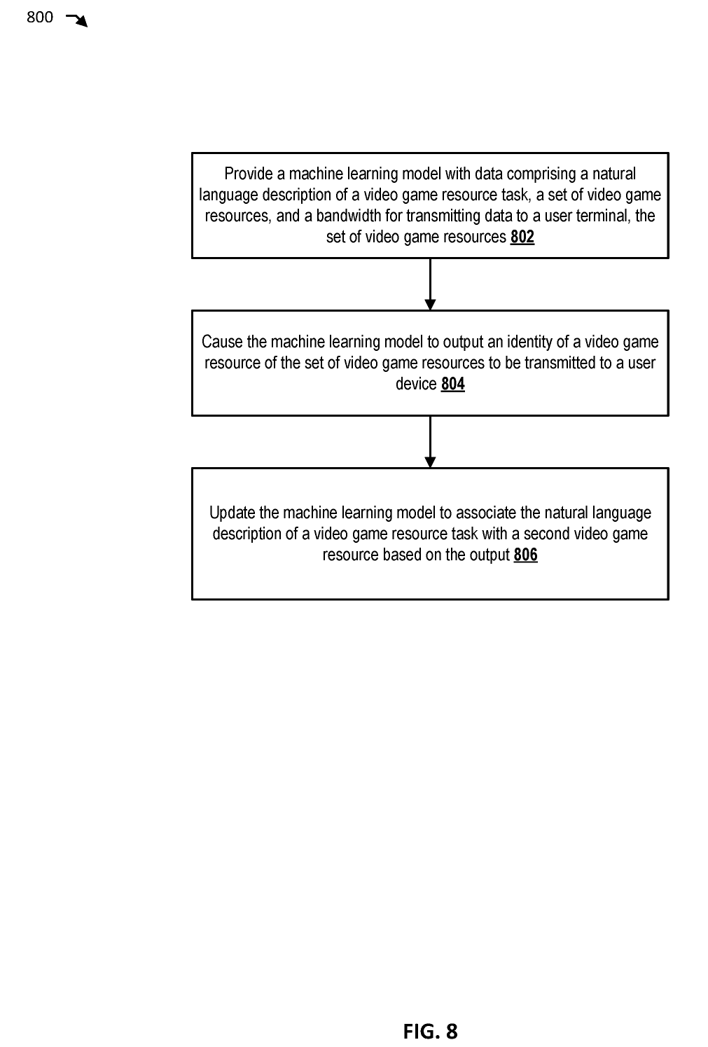

FIG. 8 is an example process 800 for training a machine learning model, according to one or more embodiments. At 802, a computing system (e.g., training system 502) can provide a machine learning model (e.g., machine learning model 508) with data comprising a natural language description of a video game development task, a set of video game resources, and a bandwidth for transmitting data to a user terminal, the set of video game resources.

At 804, the process 800 can include the computing system causing the machine learning model to output an identity of a video game resource of the set of video game resources to be transmitted to a user device (e.g., user device 202).

At 806, the process can include the computing system updating the machine learning model to associate the natural language description of a video game development task with a second video game resource based on the output. In some embodiments, the computing system can update the machine learning model to determine the video game resource based on an availability in a video game resource repository.

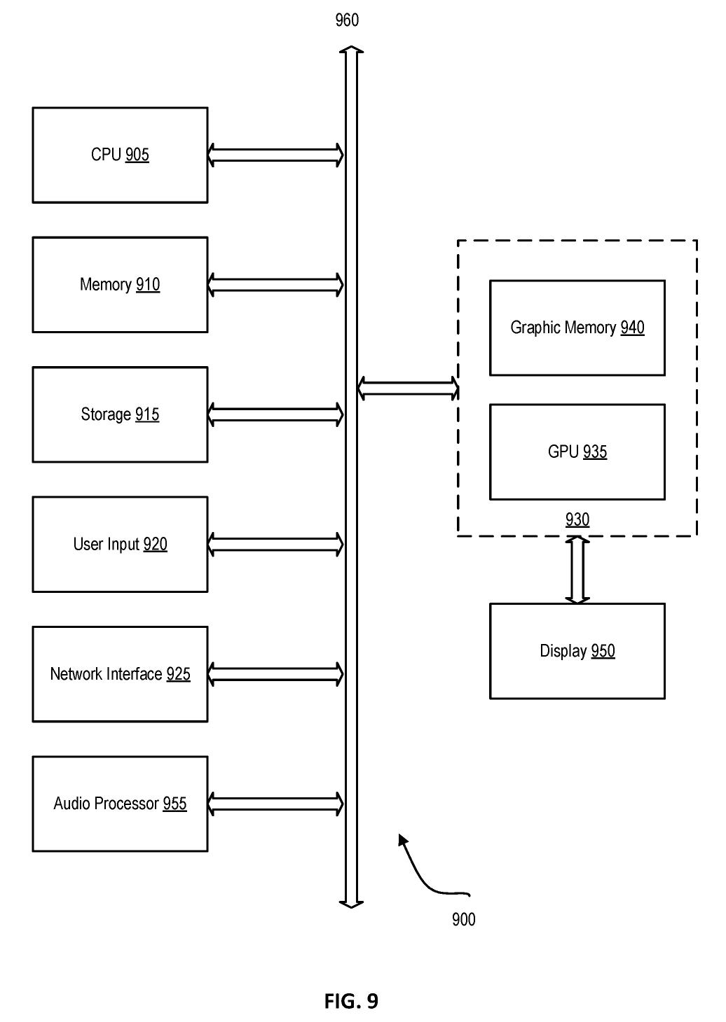

FIG. 9 illustrates an example of a hardware system suitable for implementing a computer system, according to embodiments of the present disclosure. The computer system 900 represents, for example, a video game system, a backend set of servers, or other types of a computer system. The computer system 900 includes a central processing unit (CPU) 905 for running software applications and optionally an operating system. The CPU 905 may be made up of one or more homogeneous or heterogeneous processing cores. Memory 910 stores applications and data for use by the CPU 905. Storage 915 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 920 communicate user inputs from one or more users to the computer system 900, examples of which may include keyboards, mice, joysticks, touch pads, touch screens, still or video cameras, and/or microphones. Network interface 925 allows the computer system 900 to communicate with other computer systems via an electronic communications network, and may include wired or wireless communication over local area networks and wide area networks such as the Internet. An audio processor 955 is adapted to generate analog or digital audio output from instructions and/or data provided by the CPU 905, memory 910, and/or storage 915. The components of computer system 900, including the CPU 905, memory 910, data storage 915, user input devices 920, network interface 925, and audio processor 955 are connected via one or more data buses 960.

A graphics subsystem 930 is further connected with the data bus 960 and the components of the computer system 900. The graphics subsystem 930 includes a graphics processing unit (GPU) 935 and graphics memory 940. The graphics memory 940 includes a display memory (e.g., a frame buffer) used for storing pixel data for each pixel of an output image. The graphics memory 940 can be integrated in the same device as the GPU 935, connected as a separate device with the GPU 935, and/or implemented within the memory 910. Pixel data can be provided to the graphics memory 940 directly from the CPU 905. Alternatively, the CPU 905 provides the GPU 935 with data and/or instructions defining the desired output images, from which the GPU 935 generates the pixel data of one or more output images. The data and/or instructions defining the desired output images can be stored in the memory 910 and/or graphics memory 940. In an embodiment, the GPU 935 includes 3D rendering capabilities for generating pixel data for output images from instructions and data defining the geometry, lighting, shading, texturing, motion, and/or camera parameters for a scene. The GPU 935 can further include one or more programmable execution units capable of executing shader programs.

The graphics subsystem 930 periodically outputs pixel data for an image from the graphics memory 940 to be displayed on the display device 950. The display device 950 can be any device capable of displaying visual information in response to a signal from the computer system 900, including CRT, LCD, plasma, and OLED displays. The computer system 900 can provide the display device 950 with an analog or digital signal.

In accordance with various embodiments, the CPU 905 is one or more general-purpose microprocessors having one or more processing cores. Further embodiments can be implemented using one or more CPUs 905 with microprocessor architectures specifically adapted for highly parallel and computationally intensive applications, such as media and interactive entertainment applications.

The components of a system may be connected via a network, which may be any combination of the following: the Internet, an IP network, an intranet, a wide-area network (“WAN”), a local-area network (“LAN”), a virtual private network (“VPN”), the Public Switched Telephone Network (“PSTN”), or any other type of network supporting data communication between devices described herein, in different embodiments. A network may include both wired and wireless connections, including optical links. Many other examples are possible and apparent to those skilled in the art in light of this disclosure. In the discussion herein, a network may or may not be noted specifically.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Moreover, as disclosed herein, the term “memory” or “memory unit” may represent one or more devices for storing data, including read-only memory (ROM), random access memory (RAM), magnetic RAM, core memory, magnetic disk storage mediums, optical storage mediums, flash memory devices, or other computer-readable mediums for storing information. The term “computer-readable medium” includes, but is not limited to, portable or fixed storage devices, optical storage devices, wireless channels, a sim card, other smart cards, and various other mediums capable of storing, containing, or carrying instructions or data.

Furthermore, embodiments may be implemented by hardware, software, firmware, middleware, microcode, hardware description languages, or any combination thereof. When implemented in software, firmware, middleware, or microcode, the program code or code segments to perform the necessary tasks may be stored in a computer-readable medium such as a storage medium. Processors may perform the necessary tasks.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. “About” includes within a tolerance of ±0.01%, ±0.1%, ±1%, ±2%, ±3%, ±4%, ±5%, ±8%, ±10%, ±15%, ±20%, ±25%, or as otherwise known in the art. “Substantially” refers to more than 76%, 85%, 90%, 100%, 105%, 109%, 109.9% or, depending on the context within which the term substantially appears, value otherwise as known in the art.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A method comprising:
receiving a natural language indication of a video game development task for a video game developer via a user device;
accessing a video game resource repository comprising a plurality of video game resources for a video game;
determining, via a machine learning model, a video game resource of the plurality of video game resources to be used for performing the video game development task based on the natural language indication and availability of the video game resource in the video game resource repository;
generating, via the machine learning model, a natural language summarization of using the video game resource with respect to the video game development task; and
sending the natural language summarization of the video game resource to the user device.

2. The method of claim 1, wherein the method further comprises:
parsing the natural language indication of the video game development task; and
determining a video game concept associated with the video game development task based on the parsing, wherein the video game resource is further based on the video game concept.

3. The method of claim 1, wherein the method further comprises:
transmitting a message to the user device indicating a clarifying question as to the video game development task; and
processing a response from the user device indicating a clarification of the video game development task, wherein the video game resource is further determined based on the response.

4. The method of claim 1, wherein the method further comprises:
generating control instructions for the video game resource repository to transmit the video game resource to the user device; and
transmitting the control instructions to the video game resource repository.

5. The method of claim 1, wherein the method further comprises:
determining a second video game resource for performing the video game development task;
determining a time interval for performing a video game resource subtask; and
generating control instructions for the video game resource repository to transmit the second video game resource to the user device based on expiration of the time interval.

6. The method of claim 1, wherein the method further comprises:
determining a video game developer context with respect to the video game developer performing the video game development task, wherein the video game resource is further determined based on the video game developer context.

7. The method of claim 1, wherein the method further comprises:
determining that a second video game developer is using a second video game resource to perform the video game development task; and
determining an association between the video game resource and the second video game resource, wherein the video game resource is determined based on the association.

8. The method of claim 1, wherein the method further comprises:
determining a size of the video game resource;
determining a second size of a second video game resource stored in the video game resource repository, the second video game resource associated with video game development task; and
comparing the size of the video game resource and the second size of the second video game resource, wherein determining the video game resource is based on the comparing.

9. The method of claim 1, wherein the method further comprises:
determining a size of the video game resource; and
determining a bandwidth for transmitting video game resource to the user device via a network, wherein determining the video game resource is based on the bandwidth.

10. The method of claim 1, wherein the method further comprises:
determining a type of the video game resource;
determine a second type of a second video game resource; and
determining a sequence for transmitting the video game resource and the second video game resource based on the type and the second type.

11. A computing system comprising:
one or more processors; and
one or more computer-readable media comprising a sequence of instructions that, when executed, cause the one or more processors to:
receive a natural language indication of a video game development task for a video game developer via a user device;
access a video game resource repository comprising a plurality of video game resources for a video game;
determine, via a machine learning model, a video game resource of the plurality of video game resources to be used for performing the video game development task based on the natural language indication and availability of the video game resource in the video game resource repository;
generate, via the machine learning model, a natural language summarization of using the video game resource with respect to the video game development task; and
send the natural language summarization of the video game resource to the user device.

12. The computing system of claim 11, wherein the sequence of instructions that, when executed, further cause the one or more processors to:
parse the natural language indication of the video game development task;
determine a video game concept associated with the video game development task based on parsing the natural language indication, wherein the video game resource is further based on the video game concept.

13. The computing system of claim 11, wherein the sequence of instructions that, when executed, further cause the one or more processors to:
transmit a message to the user device indicating a clarifying question as to the video game development task; and
process a response from the user device indicating a clarification of the video game development task, wherein the video game resource is further determined based on the response.

14. The computing system of claim 11, wherein the sequence of instructions that, when executed, further cause the one or more processors to:
generate control instructions for the video game resource repository to transmit the video game resource to the user device; and
transmit the control instructions to the video game resource repository.

15. The computing system of claim 11, wherein the sequence of instructions that, when executed, further cause the one or more processors to:
determine a second video game resource for performing the video game development task;
determine a time interval for performing a video game resource subtask;
generate control instructions for the video game resource repository to transmit the second video game resource to the user device based on expiration of the time interval.

16. The computing system of claim 11, wherein the sequence of instructions that, when executed, further cause the one or more processors to:
determine a video game developer context with respect to the video game developer performing the video game development task , wherein the video game resource is further determined based on the video game developer context.

17. The computing system of claim 11, wherein the sequence of instructions that, when executed, further cause the one or more processors to:
determine that a second video game developer is using a second video game resource to perform the video game development task; and
determine an association between the video game resource and the second video game resource, wherein the video game resource is determined based on the association.

18. The computing system of claim 11, wherein the sequence of instructions that, when executed, further cause the one or more processors to:
determine a size of the video game resource;
determine a second size of a second video game resource stored in the video game resource repository, the second video game resource associated with video game development task; and
compare the size of the video game resource and the second size of the second video game resource, wherein determining the video game resource is based on the comparing.

19. One or more non-transitory, computer-readable media comprising a sequence of instructions that, when executed, cause one or more processors to:
provide a machine learning model with data comprising a natural language description of a video game development task, a set of video game resources, and a bandwidth for transmitting data to a user terminal, the set of video game resources;
cause the machine learning model to output an identity of a video game resource of the set of video game resources to be transmitted to a user device; and
update the machine learning model to associate the natural language description of a video game development task with a second video game resource based on the output.

20. The one or more non-transitory, computer-readable media of claim 19, wherein the sequence of instructions that, when executed, cause one or more processors to:
update the machine learning model to determine the video game resource based on an availability in a video game resource repository.
